(19) United States
(12) Patent Application Publication
(10) Pub. No.: US 2014/0032612 A1
(43) Pub. Date: Jan. 30, 2014

(54) SYSTEM AND METHOD FOR CONTEXTUAL CONTACT MANAGEMENT

(71) Applicant: CARD2CONTACT CORPORATION, Mississauga (CA)

(72) Inventors: Madhubalan Kesavan, Mississauga (CA); Marc Castel, Orangeville (CA)

(73) Assignee: Card2Contact Corporation, Mississauga (CA)

(21) Appl. No.: 13/828,624

(22) Filed: Mar. 14, 2013

Related U.S. Application Data
(60) Provisional application No. 61/675,571, filed on Jul. 25, 2012.

(51) Int. Cl. G06F 17/30

(52) U.S. Cl. CPC G06F 17/30292
USPC 707/803

(57) ABSTRACT

The present disclosure relates to a system and method for contextual contact management, in which new contacts are stored in a contact list and are organized automatically by context. In an illustrative embodiment, as soon as a business card is collected at a networking opportunity or event, the business card is electronically stored in a mobile device for wireless transmission to a contact information processing service. In an illustrative embodiment, the business card is photographed and a digital image of the card is uploaded to a contact information processing service. Preferably, the business card information is sent together with context information identifying the context in which the contact was made. This context information is stored together with the new contact information such that a user can recall exactly when and where the contact was made, and why the contact may be important.

### FIELD OF THE INVENTION

The present invention relates generally to the field of contact management.

### BACKGROUND

Attending meetings, trade shows, conferences, seminars, and various other networking opportunities and events may often result in a large number of business cards collected from potentially useful contacts that a person may wish to have in his/her contact list. However, unless the contacts are promptly entered into a contact list after receipt of the card, the business cards may tend to be collected into a large pile together with previously collected business cards with the hope of eventually having time to enter them into a contact list. Too often the business cards lay forgotten, and after some time has passed a person may not be able to recall when or where they met the contact, and why the contact was originally thought to be potentially useful. This results in considerable wasted effort and lost opportunities due to a failure to promptly store the contact and follow up.

What is needed is an improved system and method for contact management which overcomes at least some of these limitations of the prior art.

### SUMMARY

The present disclosure relates to a system and method for contextual contact management, in which new contacts are stored in a contact list and are organized automatically by context.

As soon as new contact information, such as a business card, is collected at a networking opportunity or event, the contact information is electronically stored in a computer device. The computer device may be a smartphone, tablet, or other mobile or desktop computer devices. If a printed business card is received, the business card is photographed and a digital image of the business card is uploaded to a contact information processing service. Alternatively, the business card may be received as an electronic business card, which may be stored directly as a digital file.

Preferably, the new contact information stored in digital form is integrated with context information identifying the context in which the contact was made. For example, an electronic calendar entry in the user's mobile device may be used to provide the context—i.e. the event and location where a new business contact is made. This context information is stored together with the new contact information such that a user can recall exactly when and where the contact was made, and why the contact may be important.

Thus, in an aspect, there is provided a computer-implemented method of contextual contact management, comprising: collecting contact information for a contact; obtaining context information corresponding to the contact information; and integrating the contact information with the context information to provide contextual contact information.

In an embodiment, the context information comprises an entry in an electronic calendar, and the method further comprises integrating the entry in the electronic calendar with the contact information.

In another aspect, there is provided a computer-implemented system for contextual contact management, the system adapted to: collect contact information for a contact; obtain context information corresponding to the contact information; and integrate the contact information with the context information to provide contextual contact information.

In an embodiment, the context information comprises an entry in an electronic calendar, and the system is further adapted to integrate the entry in the electronic calendar with the contact information.

Various other types of context information may be collected, including a user's geographic location and the time of a meeting. By entering this information into a user's mobile device immediately or soon after the business card is received, the user can obtain accurate context information which is gathered from the user's mobile device, or otherwise confirmed by the user.

Other features and advantages of the present invention will become apparent from the following detailed description and accompanying drawings. It should be understood, however, that the detailed description and specific examples are given by way of illustration and not limitation. Many modifications and changes within the scope of the present invention may be made without departing from the spirit thereof, and the invention includes all such modifications.

### DESCRIPTION OF THE DRAWINGS

The invention will be better understood and objects of the invention will become apparent when consideration is given to the following detailed description thereof. Such description makes reference to the annexed drawings wherein:

FIGS. 1 and 2 show illustrative schematic block diagrams of a system architecture, in accordance with an embodiment.

FIG. 3 shows an illustrative conventional calendar view in accordance with an embodiment.

FIG. 4 shows an illustrative calendar view with an integrated contact list in accordance with an embodiment.

FIG. 5 shows a detailed view of the integrated contact list of FIG. 4.

FIG. 6 shows an illustrative schematic flow chart of a method in accordance with an embodiment.

FIG. 7 shows an illustrative schematic block diagram of a generic computer device that may provide a suitable operating environment for various embodiments.

FIG. 8 shows an illustrative use case in accordance with an embodiment.

FIGS. 9 to 20 show screen captures of the system and method in accordance with an illustrative embodiment.

In the drawings, embodiments of the invention are illustrated by way of example. It is to be expressly understood that the description and drawings are only for the purpose of illustration and as an aid to understanding, and are not intended as a definition of the limits of the invention.

### DETAILED DESCRIPTION

As noted above, the present invention provides a system and method for contextual contact management in which new contacts are stored in a contact list and are organized automatically by context.

In one embodiment, the system and method allows a user to process contact information as soon as it is received. The context in which the contact information was received is also noted, and this context information is integrated with the new contact information. For example, an electronic calendar application is queried for event, location and time, and integrated with the new contact information. The contextualized contact information is then stored for later reference.

Advantageously, because the new contact information is entered into the user's contact list immediately or shortly after the business card is received, together with context information detailing how the contact was made, what was previously a tedious, time consuming effort to enter business card data manually into a contact list and to follow up can be substantially avoided, and each networking opportunity can be maximized.

In an embodiment, if the contact information is received as a printed business card, the business card can be photographed, and from virtually any geographic location, the digital image of the business card is transmitted to a contact information processing service for transcription. The business card is transcribed, and returned to be integrated with the context information before being stored for later reference.

Alternatively, the business card may be received as an electronic business card, which may be stored directly as a digital file, and may be integrated with the context information before being stored for later reference.

Illustrative embodiments of the invention will now be described with reference to the figures.

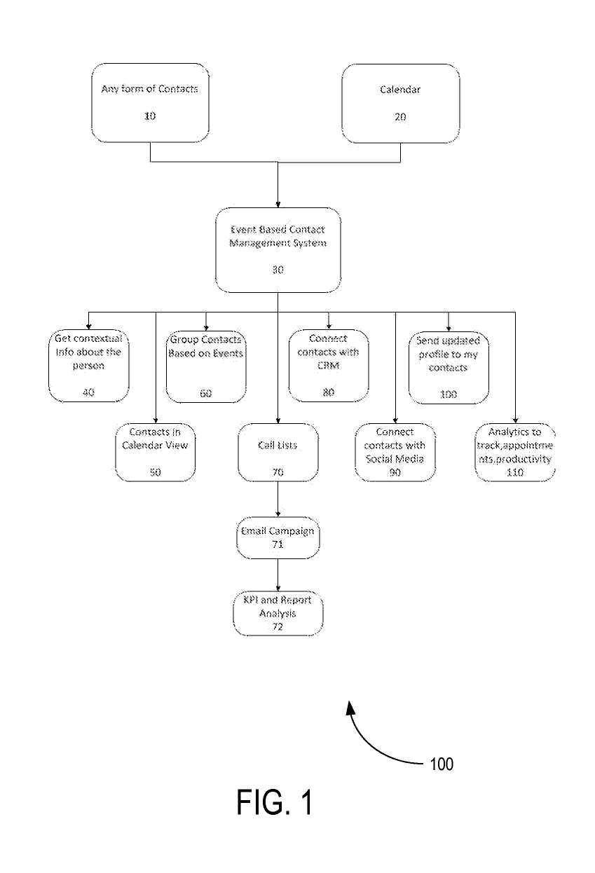

Now referring to FIG. 1, shown is a system 100 in accordance with an illustrative embodiment. As shown, system 100 includes contact information 10 received from a new contact. The contact information may be provided in one of any number of formats, including a printed business card, an electronic card, a .vcf file, a collection of contact data, or even a piece of paper which includes the contact details. Thus, the contact information can be in digital format or in a printed material format.

Still referring to FIG. 1, shown is an illustrative electronic calendar 20 for providing context information on where a contact was made. Electronic calendar 20 may be embodied in an electronic format, and may be accessible from a user's mobile device as an electronic calendar client or as a web app accessible from the mobile device.

Still referring to FIG. 1, shown is a contact management module 30 which is configurable to integrate the contacts from 10 with context information from electronic calendar 20.

In an illustrative embodiment, the contact management module 30 may facilitate a user taking a picture of a printed business card or other paper materials on which the contact information is provided, and to store a digital image of the business card to be communicated to a contact information processing service. Alternatively, the contact can be read, scanned, imported or loaded from virtually any digital source.

In an embodiment, the digital image of the business card or other business contact information is integrated with an electronic calendar entry on the user's mobile device, and optionally associated with location data based on a current GPS reading on the mobile device. This information may optionally be transferred together with the contact information to the contact information processing service. The digital images of the business card are then processed at the contact information processing location and converted into formatted contact information for return to the user's mobile device or to a backend server for processing and integration with the context information.

In an embodiment, the contact management module 30 is configured to integrate the electronic calendar information including time, date and location information to provide the context in which the new business contact was met. Contact management module 30 matches the contacts with current electronic calendar information together with location and time, or optionally allows the user to choose any electronic calendar events that happened in the past.

Alternatively, in addition to context information obtained from the electronic calendar, contact management module 30 may also obtain context information from other modules in the mobile device including a clock, a GPS module, a mapping application, and various social media applications. More generally, in various illustrative embodiments, contact management module 30 may be configured to provide the following different functionalities as shown in FIG. 1.

In one illustrative embodiment, using the provided contact information 10, contact management module 30 facilitates collection of additional context information about the contact. For example, the module 30 may optionally collect additional information about a contact based on an automated Internet search via a search engine, and provide a live link to a website address provided in the contact information. Any additional information located by the Internet search may also be listed for subsequent reference or review.

In another illustrative embodiment, the module 30 may be configured to help users identify where and when the contact was made in an electronic calendar view. Thus, rather than being just added to the contact list, the module 30 will help the users to visually identify where and when a contact was made in the electronic calendar view. Thus, for example, if a user cannot recall a contact's name but remembers the date and event where the meeting occurred, backtracking and referencing the electronic calendar view on the user's mobile, tablet or computer device may provide the context information necessary to quickly find and access a link to the desired contact information. Users can thus navigate through past electronic calendar entries to find contacts they have met at various networking opportunities and events.

In another illustrative embodiment, as shown at 60, contacts may be organized into a group of contacts that the user met at an event. Thus, for example, two dozen business cards collected from various contacts at a convention may be placed into a group called “convention contacts”, and the association with a particular event will allow the contact management module 30 to better organize the list of contacts for later follow up.

In another illustrative embodiment, as shown at 70, contact management module 30 may be configured to generate a call list, whereby a user can choose specific contacts or a group of contacts from an event for further follow-up. The call list may include links to the full contact information such that, when the follow-up call is being made, the user can quickly reference the details for a contact as the call is being made.

In another illustrative embodiment, as shown at 71, contact management module 30 may be configured to generate an email campaign list. The email campaign list may be integrated with the call lists, such that both a follow-up call and an email message may be sent to specific contacts or to a group of contacts.

In yet another illustrative embodiment, as shown at 72, contact management module 30 may be configured to generate reports, which may help analyse contact follow-up and provide metrics on call lists and email campaigns. In an embodiment, a user can obtain key performance indicator metrics such as how many email campaigns has been sent, the number of users who read the message, the number of users who clicked any appropriate links in the message, and the number of users who are not interested in the campaign based on the analysis report.

In still another embodiment, as shown at 80, contact management module 30 may be integrated with existing enterprise client relationship management (CRM) tools, such that the user's new contacts can be accessed and managed through the enterprise CRM application. This may provide greater flexibility in sharing the contact information collected by a number of users attending the same event, for example.

Still referring to FIG. 1, as shown at 90, contact management module 30 may be configured to allow users to connect with their contacts through various social media portals. This is yet another possible method of following up with the new contact.

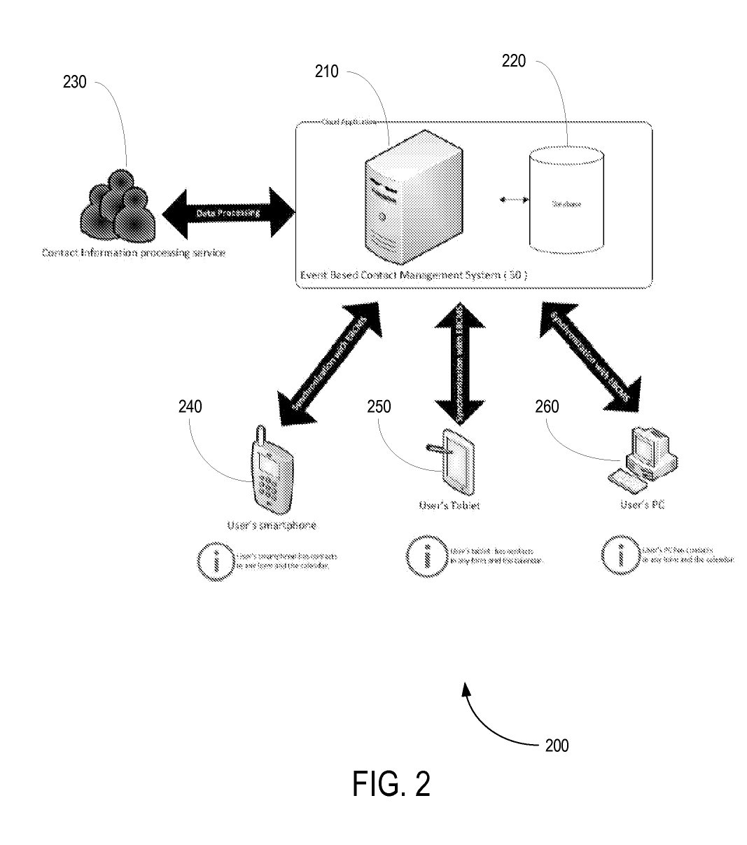

In another embodiment, contact management module 30 may be a client app connected to a backend event based contact management system (EBCMS), such as the EBCMS 210 shown in FIG. 2. EBCMS 210 maintains an updated database of all collected contact information for a user. In an embodiment, the EBCMS 210 may be configured to store the contact information for all contacts uploaded to the database by a user, such that if the user updates his/her contact details such as email address, phone, company and address, the updated contact details for the user as obtained from the user's mobile device can be directly pushed to all of the user's contacts. The user's profile update may be performed from the user's mobile device, tablet or computer by accessing the EBCMS 210, where all the contacts have been stored. Once the profile is updated, the user can initiate sending the new contact details to all of the user's contacts. The EBCMS 210 can then send the updated contact information to all contacts in the user's contact list.

In still another illustrative embodiment, contact management module 30 may be configured to allow an enterprise to track, analyse, and monitor their employees' contact generation activities. For example, for a sales force, contact management module 30 may track the networking opportunities attended, contacts the users have formed, and sales leads that have been generated. Companies can control their employee's performance, whom they have met in their work hours, how many sales leads they have generated, and what is their progress update.

FIG. 2 shows an illustrative schematic system architecture 200 in accordance with an embodiment. As shown, architecture 200 includes EBCMS 210 which may store and execute contact management module 30 of FIG. 1. EBCMS 210 is operatively connected to a database 220 which stores user information, contact information, and calendar information. EBCMS 210 is also operatively connected to a contact information processing service 230 which may be remotely located from EBCMS 210. Contact information processing service 230 receives contact information in various forms (e.g. a digital image of a business card) and returns contact information in a format suitable for integrating into a contact list or customer relationship management system.

Still referring to FIG. 2, shown are various types of user computer devices including, for example, a smartphone 240, tablet 250, or a desktop PC 260. Each user device 240, 250, 260 may be configured to remain synchronized with EBCMS 210 by uploading and updating contact information, and the calendar information for each user.

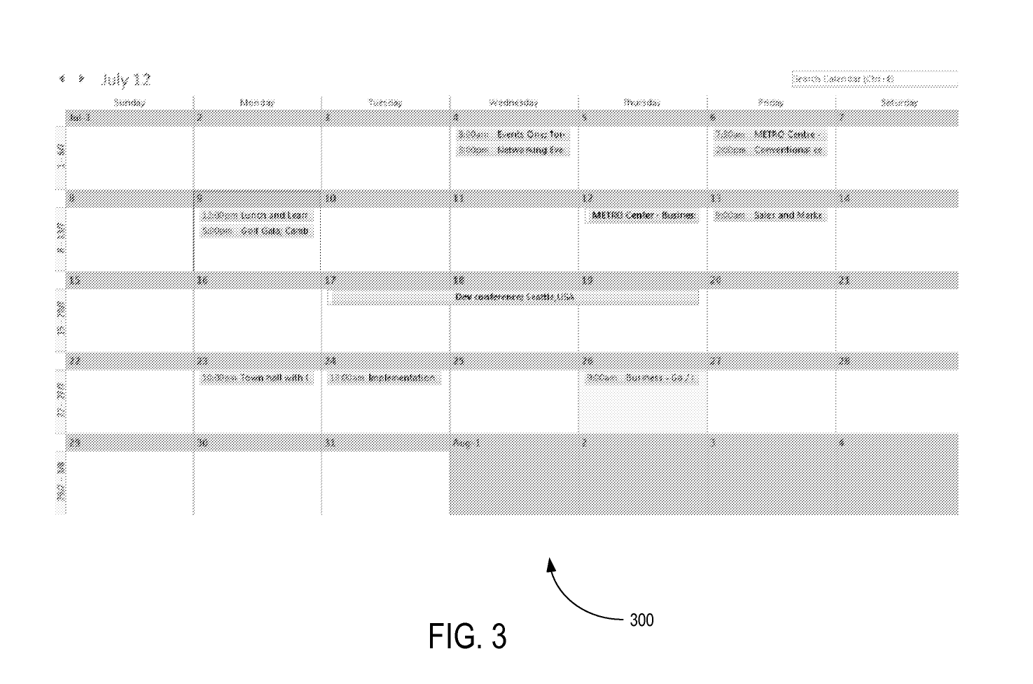

Now referring to FIG. 3, shown is an illustrative calendar 300 in accordance with an embodiment. As shown in this example, calendar 300 shows a conventional monthly view with various meetings and other events scheduled at different time slots. Alternatively, it will be appreciated that a weekly view or a daily view may be shown with additional details provided for each meeting or event based on the amount of space available.

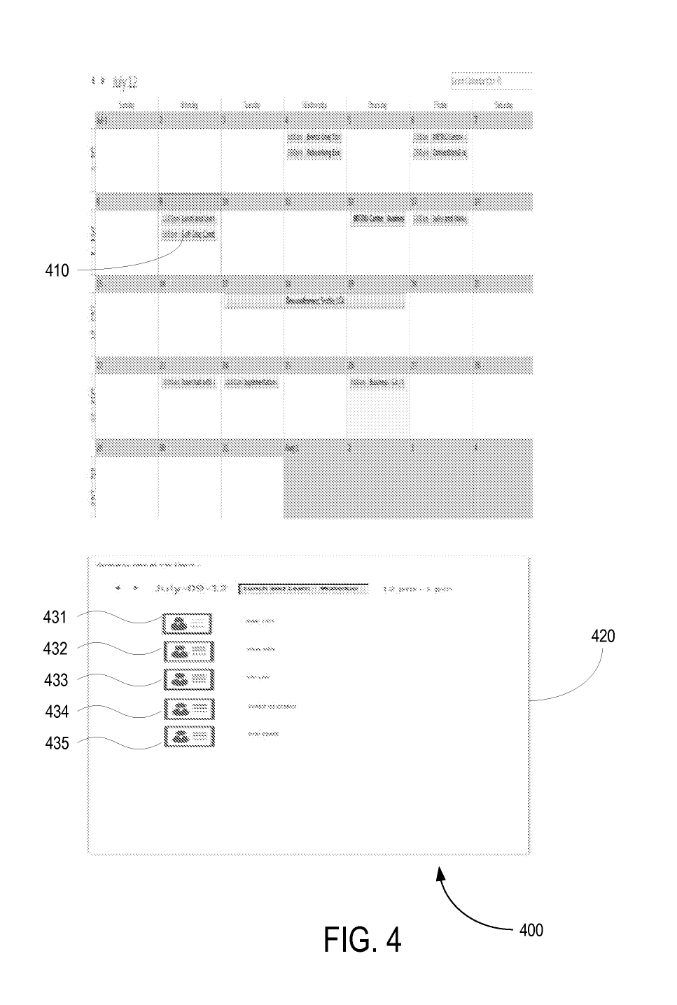

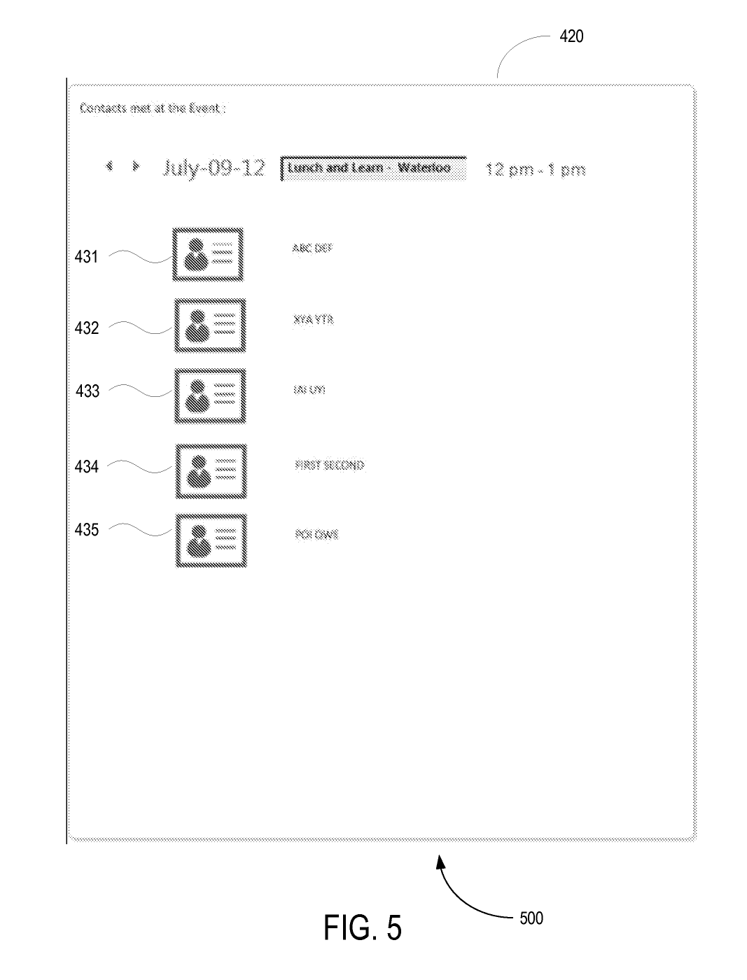

Now referring to FIG. 4, shown is an illustrative calendar view with an integrated contact list in accordance with an embodiment. As shown, for a particular calendar entry or event 410, a corresponding detailed window may be shown in which a number of contacts made at the event 410 are listed. In this illustrative example, a plurality of contacts 431 to 435 are shown in a separate display area or pop-up window 420. In an embodiment, these contacts are associated with a calendar entry to provide context when adding a new contact's information. For example, when photographing a business card to generate a new contact entry, a user may given an option to associate the contact with a currently scheduled event, or alternatively to select a past event from a calendar to manually associate a new contact with a particular event. In this illustrative example, the user has made five contacts at an event, and all five new contacts are listed in the calendar view such that a user can contextualize where the contacts were made.

FIG. 5 shows a more detailed view of the contact list of FIG. 4 in which each of the contacts made at a particular event are listed in a summary format. However, in an embodiment, suitable links may be created and located beside each contact in the list such that a user can easily navigate to another screen to obtain more detailed contact information about a particular contact.

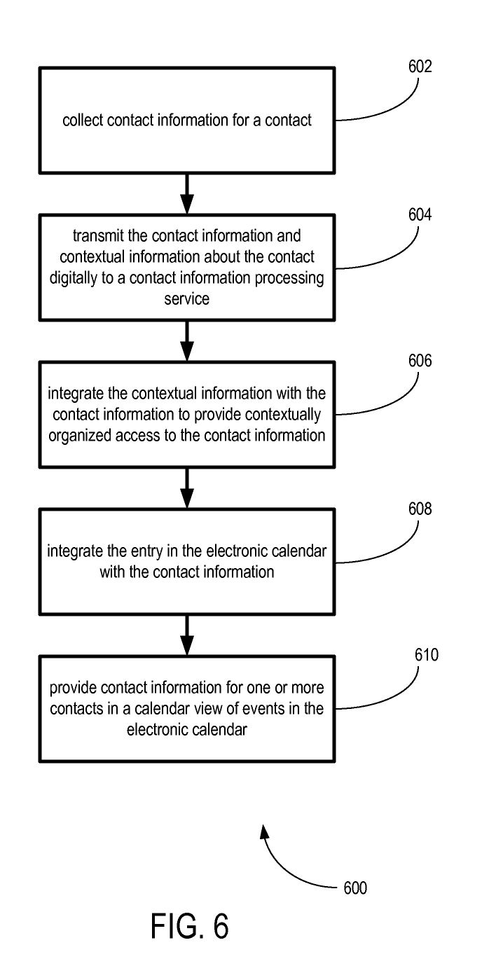

Now referring to FIG. 6, shown is a schematic flow chart of a method 600 in accordance with an embodiment. As shown, at block 602, method 600 collects contact information for a contact. Method 600 then proceeds to block 604, where method 600 optionally transmits the contact information and context information about the contact digitally to a contact information processing service.

Method 600 then proceeds to block 606 where method 600 integrates the contact information with context information to provide contextual contact information.

In an embodiment, method 600 proceeds to block 608, where method 600 integrates the entry in the electronic calendar with the contact information.

In another embodiment, method 600 proceeds to block 610 where method 600 provides contact information for one or more contacts in a calendar view of events in the electronic calendar.

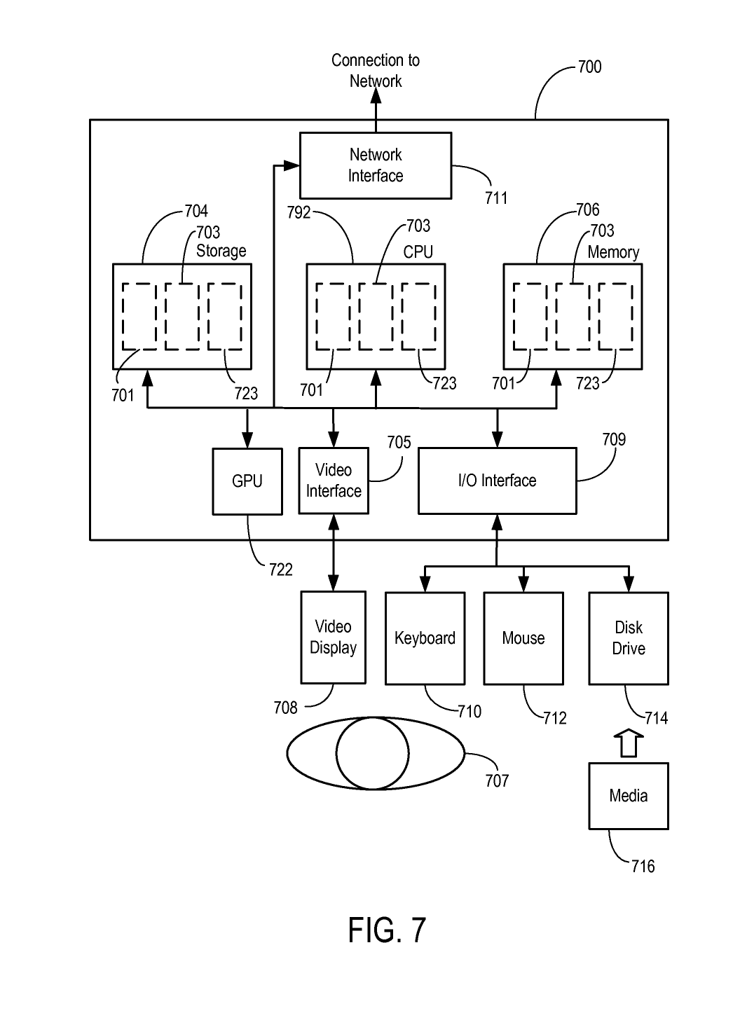

Now referring to FIG. 7, the present system and method may be practiced in various embodiments. A suitably configured generic computer device, and associated communications networks, devices, software and firmware may provide a platform for enabling one or more embodiments as described above. By way of example, FIG. 7 shows a generic computer device 700 that may include a central processing unit (“CPU”) 702 connected to a storage unit 704 and to a random access memory 706. The CPU 702 may process an operating module 701, application program 703, and data 723. The operating module 701, application program 703, and data 723 may be stored in storage unit 704 and loaded into memory 706, as may be required. Computer device 700 may further include a graphics processing unit (CPU) 722 which is operatively connected to CPU 702 and to memory 706 to offload intensive image processing calculations from CPU 702 and run these calculations in parallel with CPU 702. An operator 707 may interact with the computer device 700 using a video display 708 connected by a video interface 705, and various input/output devices such as a keyboard 710, mouse 712, and disk drive or solid state drive 714 connected by an I/O interface 709. In known manner, the mouse 712 may be configured to control movement of a cursor in the video display 708, and to operate various graphical user interface (GUI) controls appearing in the video display 708 with a mouse button. The disk drive or solid state drive 714 may be configured to accept computer readable media 716. The computer device 700 may form part of a network via a network interlace 711, allowing the computer device 700 to communicate through wired or wireless communications with other suitably configured data processing systems (not shown).

In an embodiment, an on board camera 718 may be integrated with the generic computer device to capture photos and store the photos in memory 706. The photos may also be transmitted wirelessly via network interface 711 to a server connected to the network.

The generic computer device 700 may be embodied in various form factors including desktop and laptop computers, and wireless mobile computer devices such as tablets, smart phones and super phones operating on various operating systems. It will be appreciated that the present description does not limit the size or form factor of the computer device on which the present system and method may be embodied.

### Use Cases

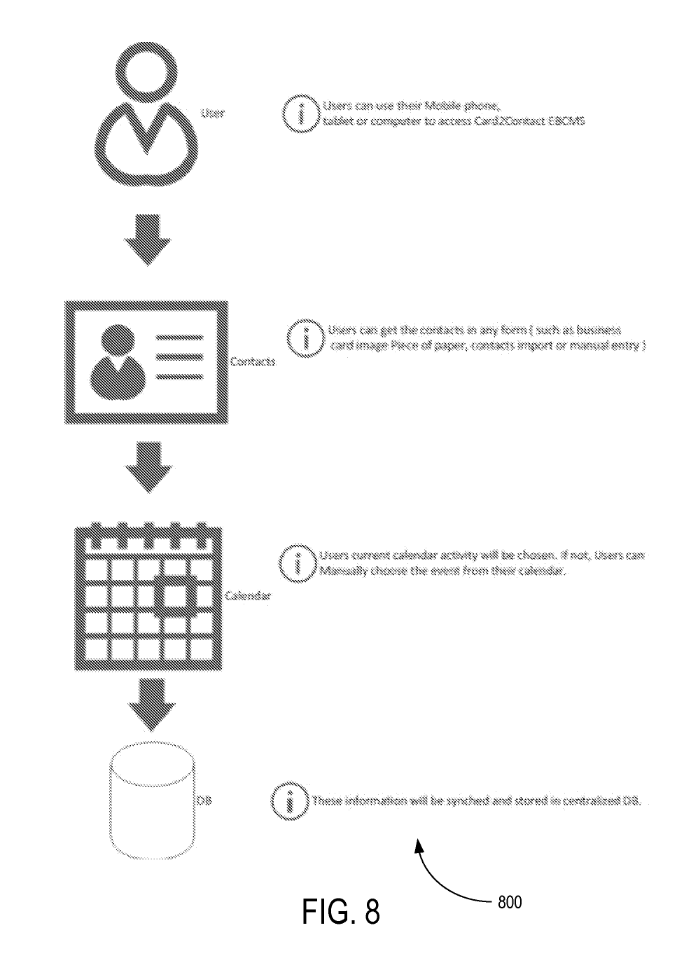

FIG. 8 shows an illustrative use case. As shown, a user may use any one of a mobile phone, tablet or computer to access the EBCMS 210 as described earlier. The new contact information may be received in any form, including the possibility of obtaining a printed business card or an electronic business card. Optionally, a printed business card or an electronic business card may be forwarded to a contact information processing service to be converted into a standard digital contact information format for inclusion into a contact list and for integration with context information (e.g. one or more calendar events).

Still referring to FIG. 8, in an embodiment, by default, the user's current activity scheduled in the calendar may be used to provide the context information for a new contact. Alternatively, a user may be able to manually override and select a past event to which a contact is to be associated after completion of the event. The contact information and the calendar context information is thus integrated, and uploaded to the EBCMS 210 to be stored for later retrieval, and to be updated from time to time.

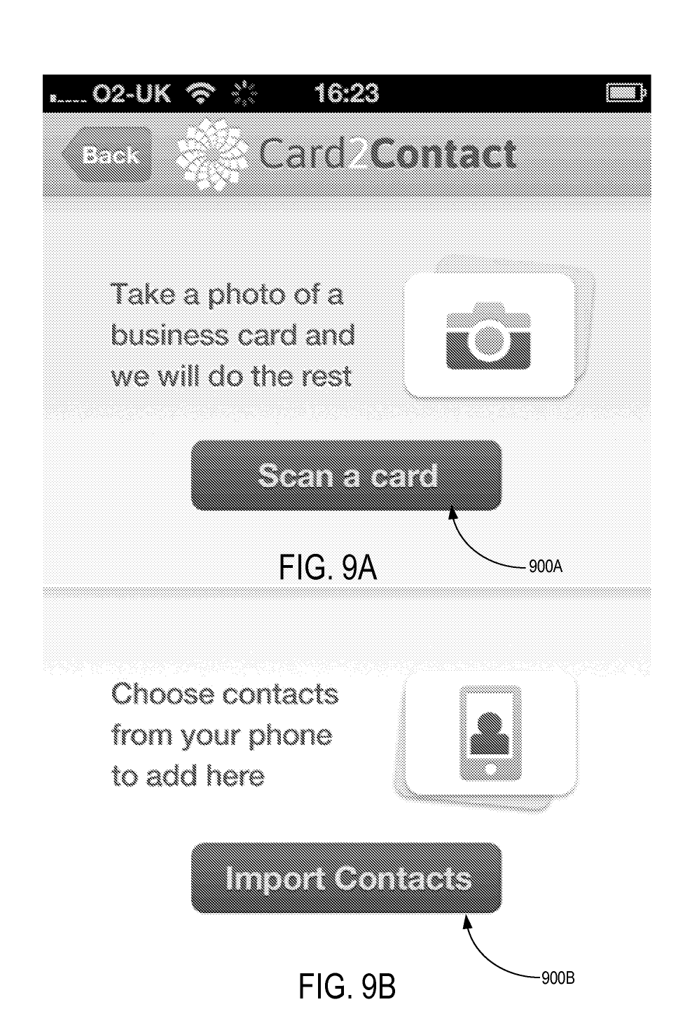

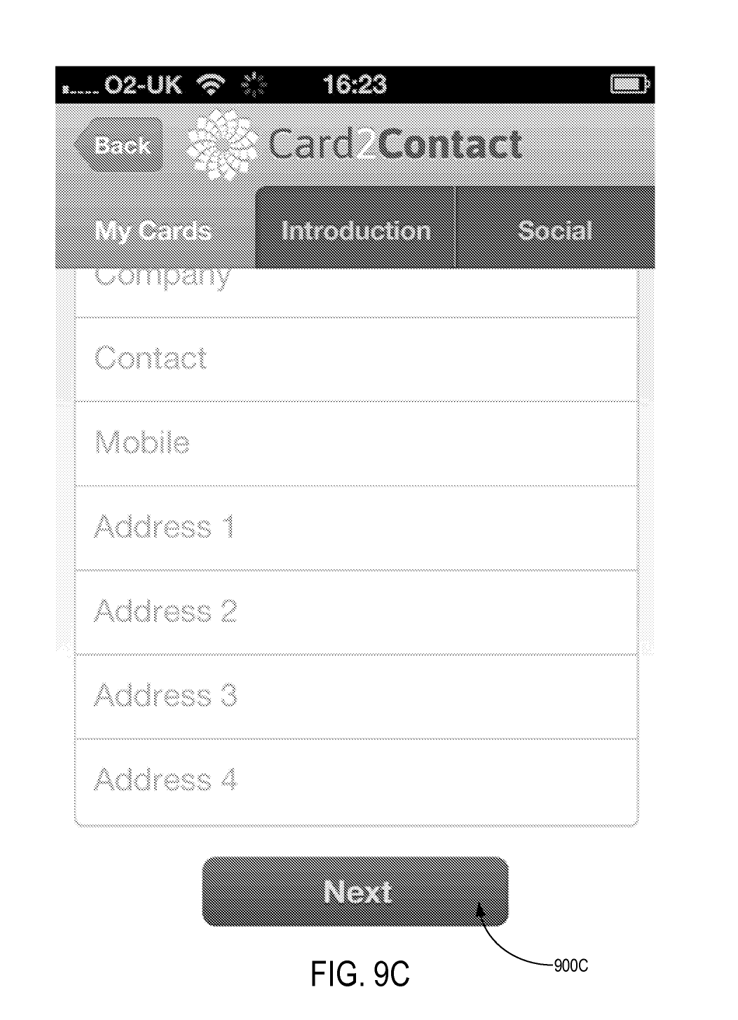

Now referring to FIGS. 9 to 16, shown are screen captures of the system and method in accordance with an illustrative embodiment.

As shown in FIG. 9A, the system provides an option to “scan a card” by selecting button 900A on a smart phone or tablet device (e.g. computer device 700) having an on board camera (e.g. camera 718). The on board camera takes a photo of the business card and wirelessly uploads the photo to a backend server connected via the internet.

Alternatively, as shown in FIG. 9B, the system provides an option to “import contacts” already entered into the smart phone or tablet device (e.g. computer device 700). In this manner, existing contacts may also be added to the contextual contact management system of the present disclosure.

Yet another alternative is shown in FIG. 9C, where the system provides an input screen for a user to directly enter all details for a new contact, including the company, contact name, mobile phone number, email address, and mailing address. This option may be used of the new contact has run out of business cards, and either provides the details or sends an email with all of the contact details that can be copied into the screen shown in FIG. 9C.

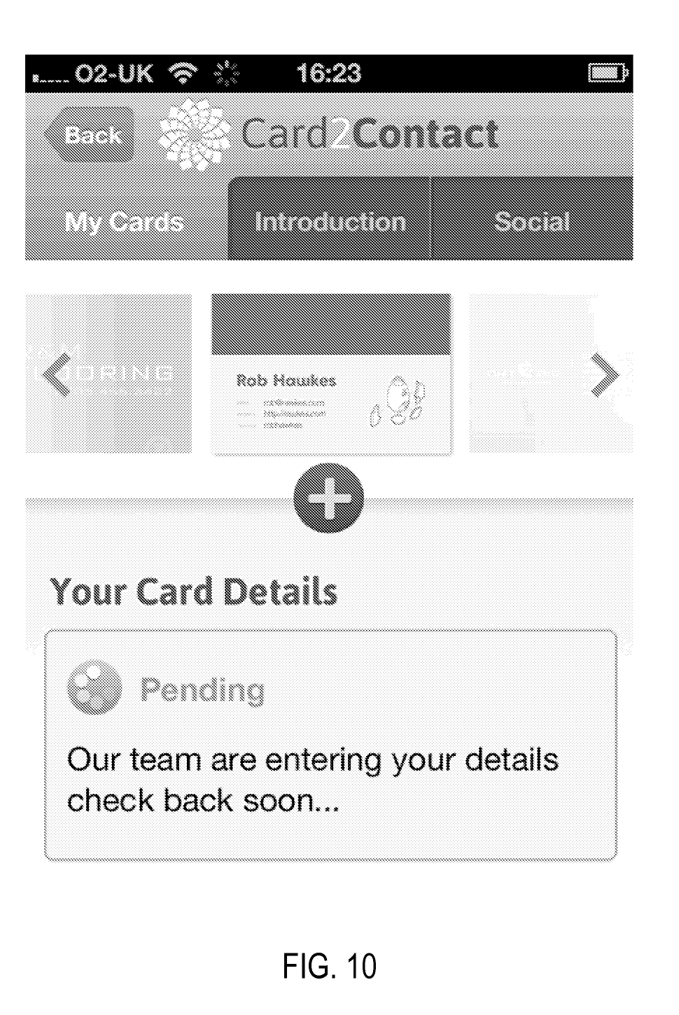

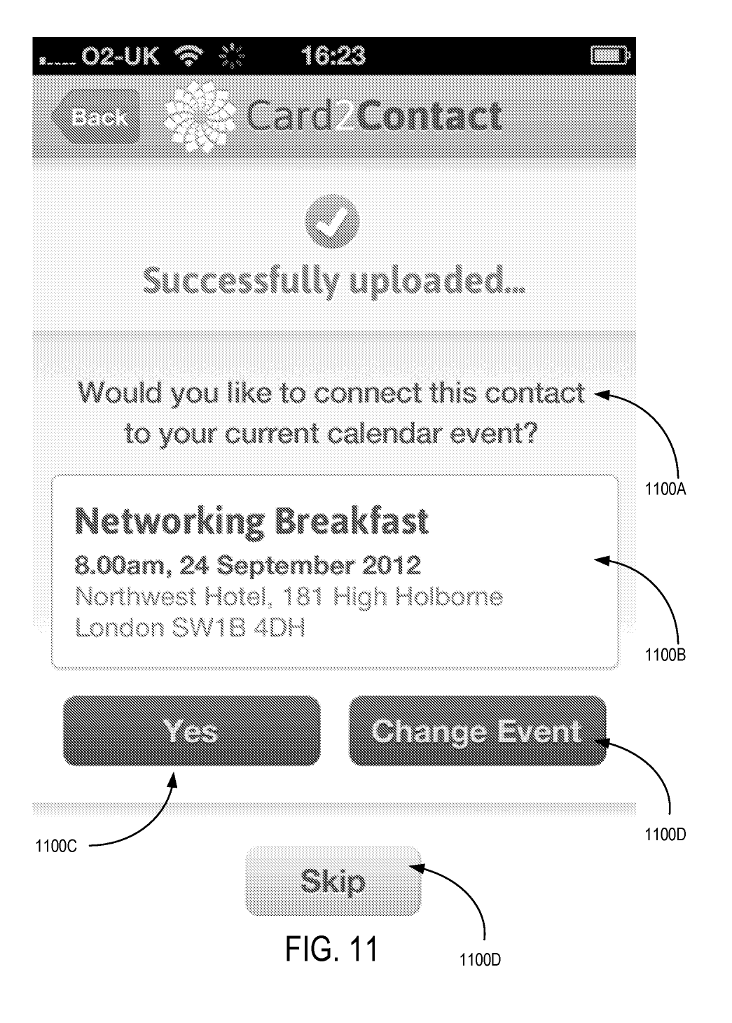

Now referring to FIG. 10, shown is an illustrative example of a card that has been scanned (i.e. photographed) and in the process of being uploaded. Once the photo is uploaded to a backend server and processed, the contact details on the card are entered into the contextual contact management system. Upon successful uploading, a success message is displayed, as shown by way of example in FIG. 11.

Optionally, upon successfully uploading a contact, the system provides an option, as shown at 1100A, for the user to connect the contact to the current calendar event. Thus, if a contact has just been made at a networking breakfast as described at 1100B, the user has the option to connect the contact to this event by selecting “Yes” at 1100C, or alternatively to “Change Event” at 1100D in order to select a previously scheduled event that has already been concluded. Finally, the user also has the option to “Skip” this step at 1100D to bypass this connection step altogether.

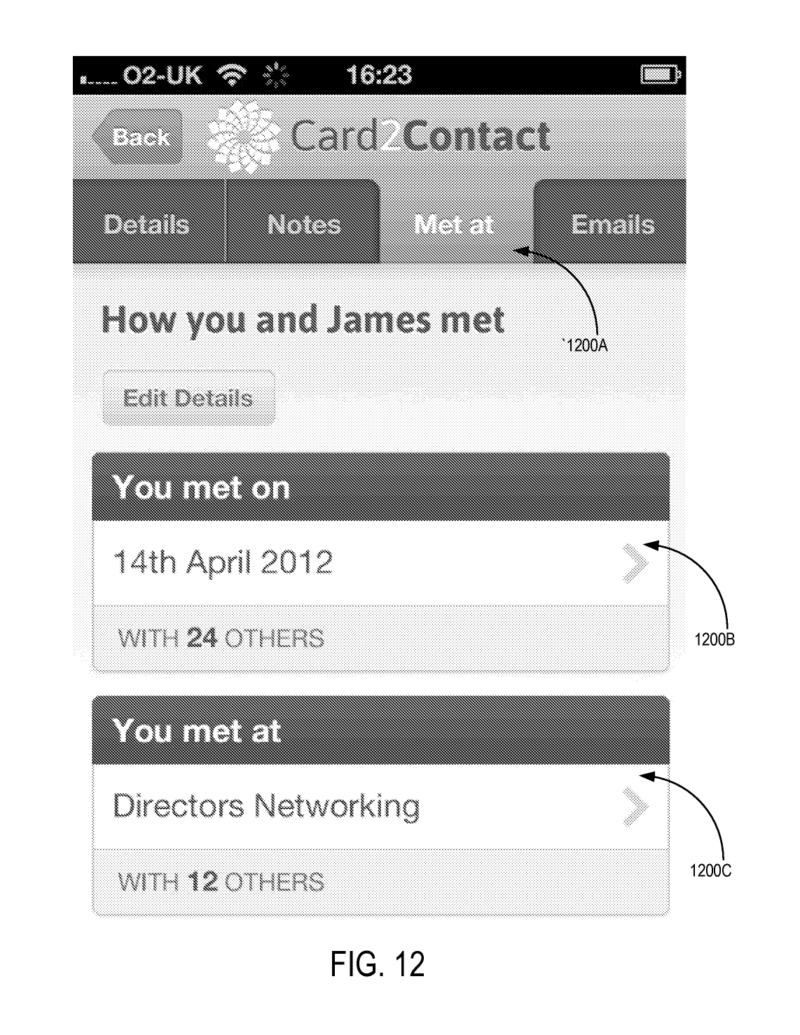

As shown in FIG. 12, upon successfully connecting a new contact with a calendar event, a summary screen of how a contact was made may be displayed in a “Met at” window 1200A. For example, as shown in FIG. 12, the details on the date 1200B and event 1200C at which the contact was made may be displayed, together with the total number of contacts made on the specified date, and at the specified event.

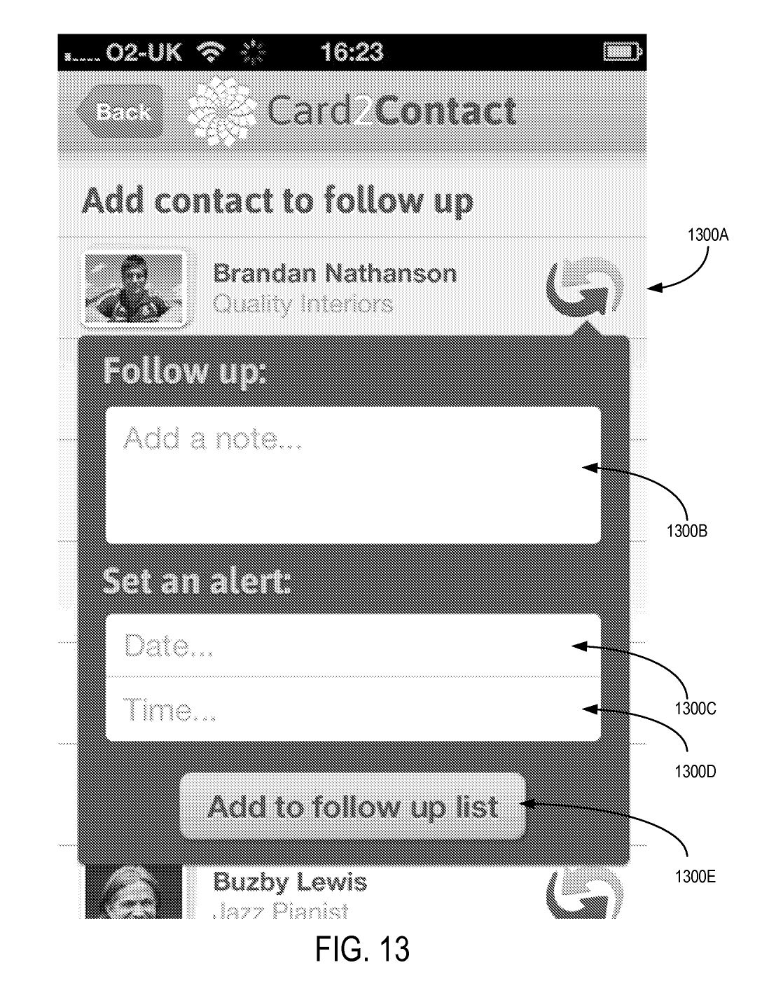

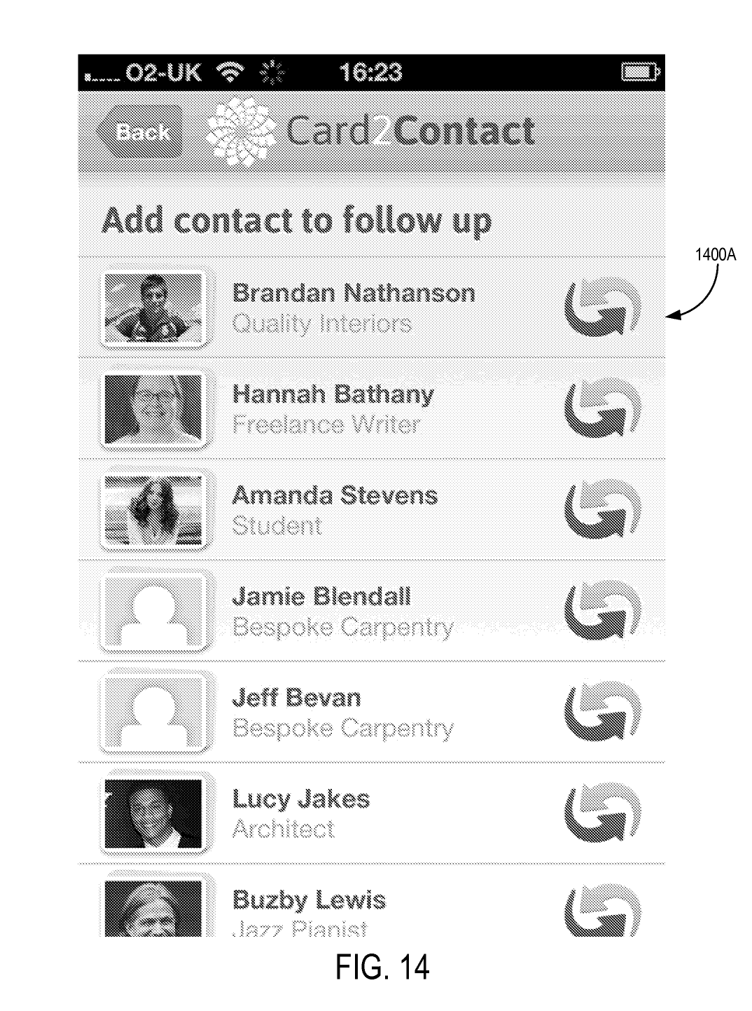

Now referring to FIG. 13, in another embodiment, the system may provide a “Follow up” option to provide a reminder to follow up with the contact 1300A that has just been made. By way of example, in FIG. 13, a note may be added to a “Follow up” window, and an alert to follow up may be added by specifying a date 1300C and a time 1300D. Selecting “Add to follow up list” at 1300E adds the contact to a list of contacts 1400A to follow up with, as shown by way of example in FIG. 14.

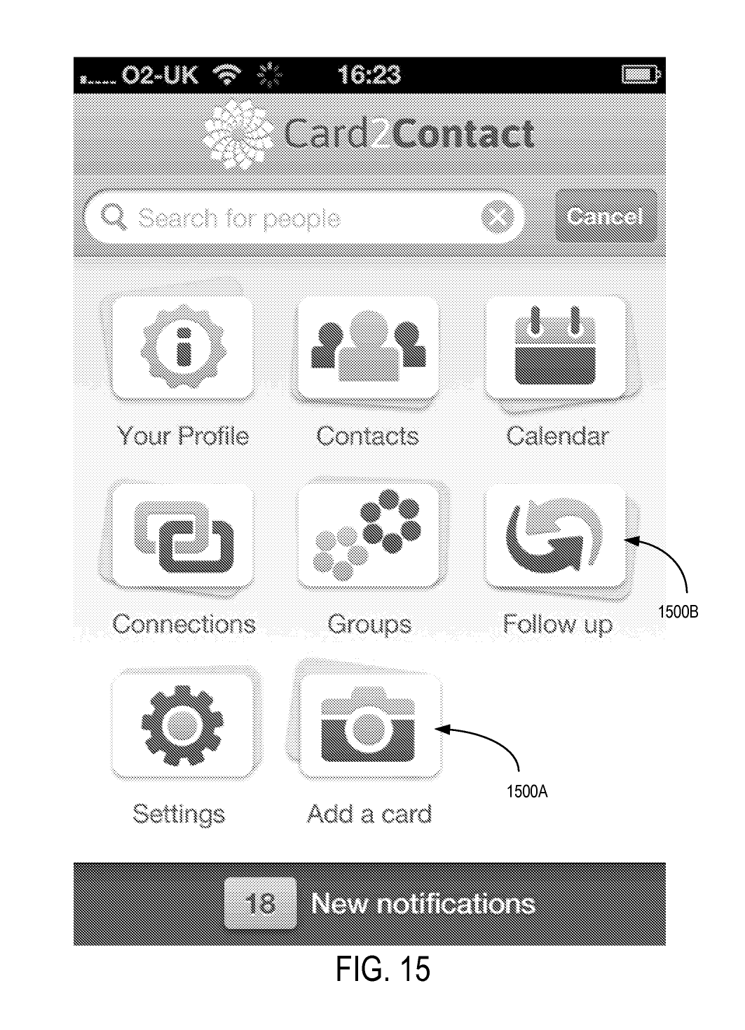

Now referring to FIG. 15, shown is an illustrative home screen with various selectable features including an “Add a card” feature 1500A, as illustrated above with reference to FIG. 9A to FIG. 12, and a “Follow up” feature 1500B as illustrated in FIGS. 13 and 14. Other features in this illustrative example include a Profile feature, a Contacts feature, a Calendar feature, a Connections feature, a Groups feature, and a Settings feature.

The Profile feature may provide a screen for entering a user profile, including detailed contact information such as name, personal contact details including contact number, address, business contact details, profile images and business card images. It may also be provided as a .vcf electronic business card, for example.

The Contacts feature may provide a list of contacts that may be sorted alphabetically, or sorted by the most recent contacts that have been entered to allow follow up or further action. Every contact will have the notes section, where the user can enter his/her personal notes about the contact. This will help to remember what the last discussion was and add some follow-up notes.

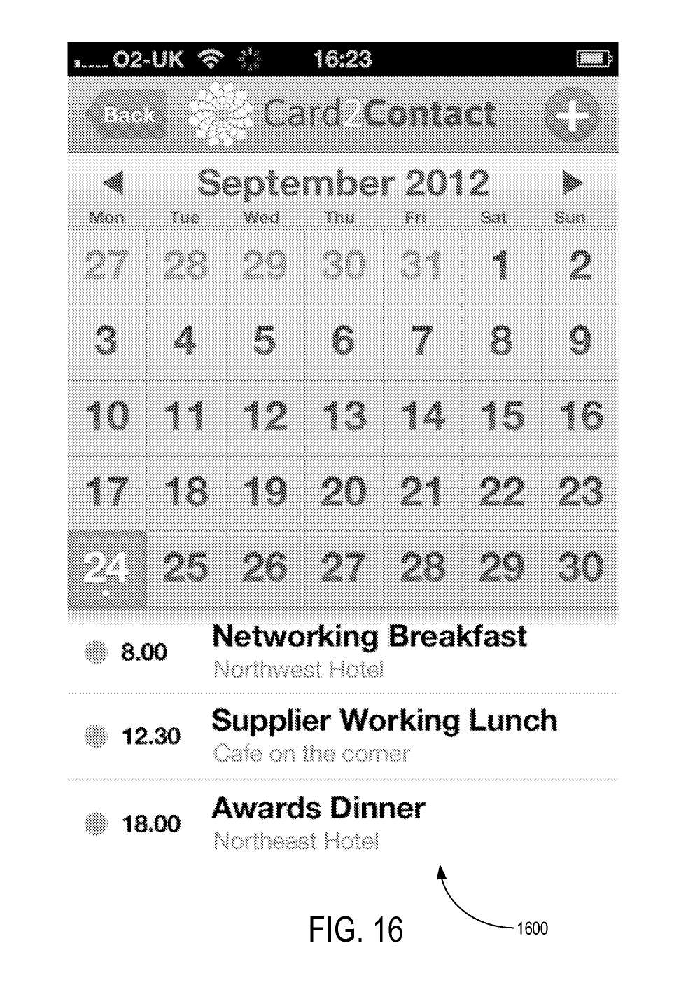

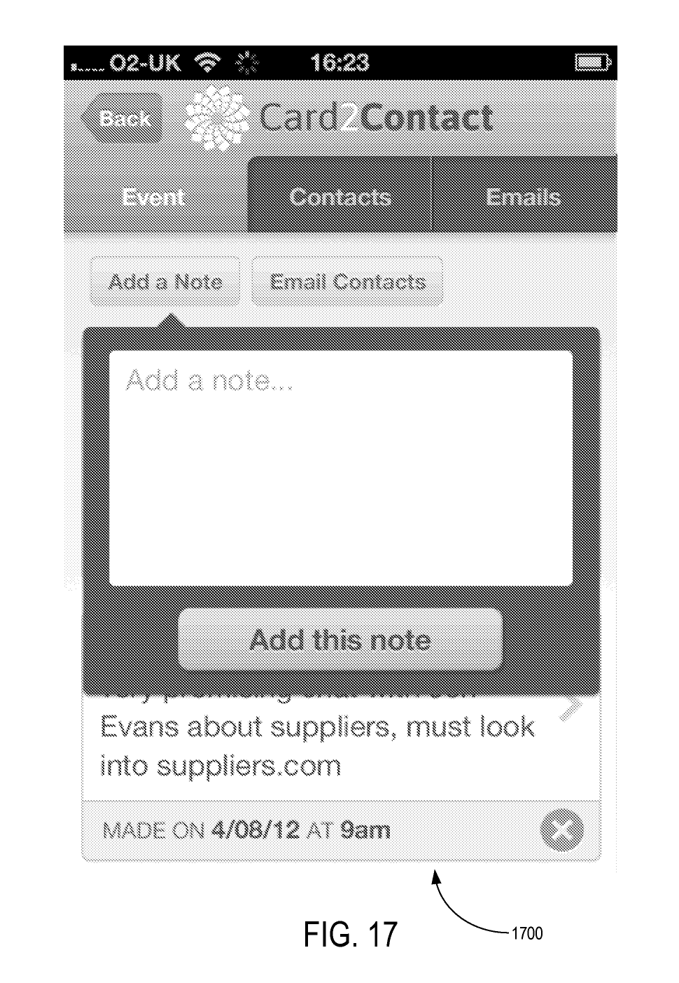

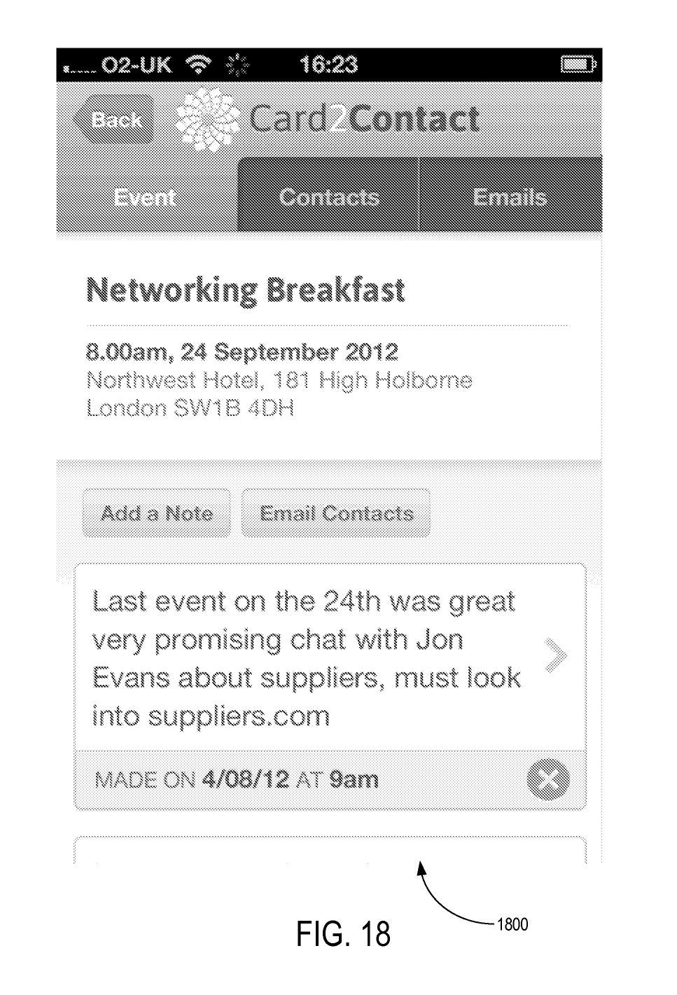

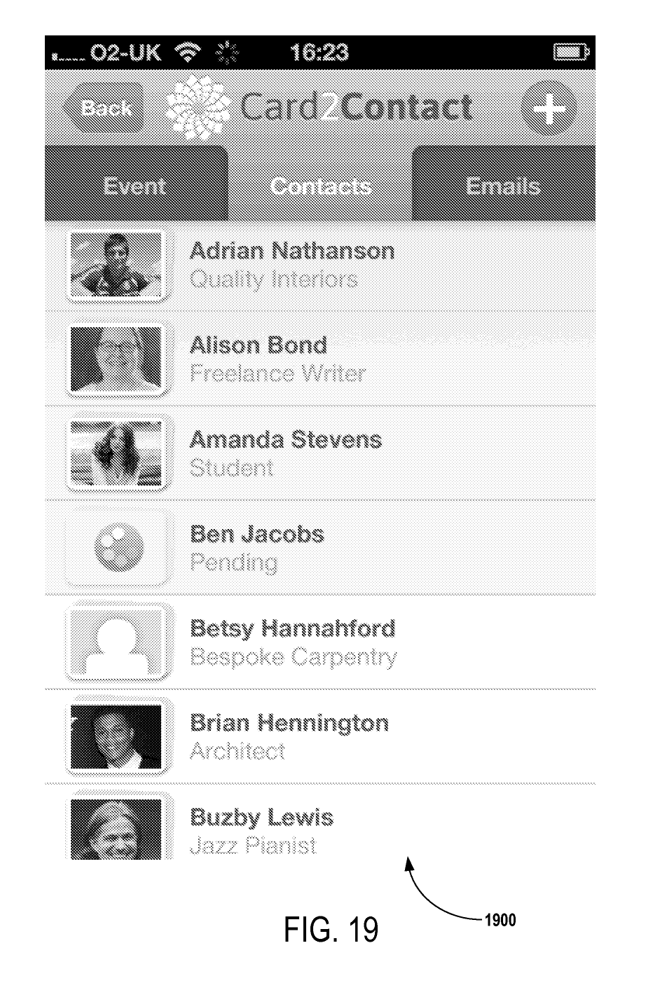

The Calendar feature may provide the calendar view as earlier illustrated with reference to FIG. 3 and FIG. 4, and shown by way of illustration in FIGS. 16 to 20.

The Calendar will list all the events for the chosen date. Upon selecting a particular event, it will show the event description, date, time and location. It will provide an option to create a group those are met in this event. Contacts tab will list the contacts met at the specific event and email tab will allow to view the emails sent and received with these contacts.

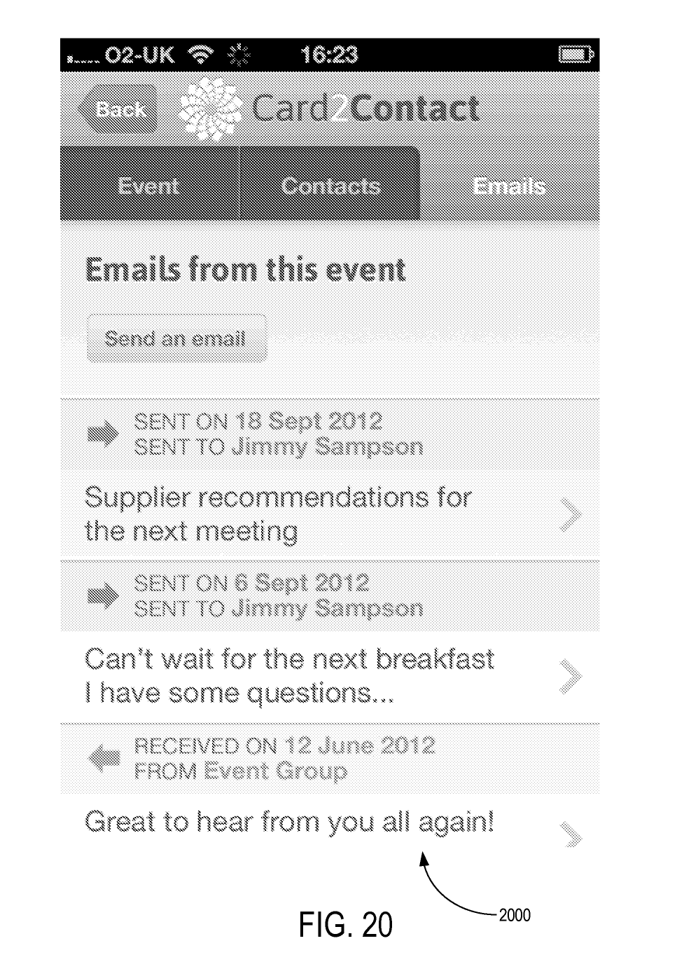

Referring to FIGS. 16 to 20, shown are illustrative screen captures of a calendar 1600, and an option for adding details of an event listed in the calendar, as shown at 1700 and 1800. Also shown is a listing of contacts 1900 including a contact pending to be added. In an embodiment, as shown in FIG. 20, emails associated with a particular event in the calendar may be organized in a group such that they are all available for review in context of the particular calendar event. This also allows a user to more easily confirm follow up communication with all contacts made at an event listed in the calendar.

The Group feature may provide a list of contacts that have been sorted by group, for example as business associates and personal contacts, or by other specific, identifiable groups that logically make sense to keep together (e.g. by organization, industry, association, events where they were met etc.). This group feature may allow follow up with contacts in a more organized fashion and to more easily remember where they were met and who were all there in their meetings.

Finally, the Settings feature may provide various options that a user may select based on personal preferences in how contacts are entered into the system and organized.

As illustrated by example, by immediately providing context in which new contacts are made, the present system and method allows users to follow up with new contacts promptly and with confidence.

Thus, in an aspect, there is provided a computer-implemented method of contextual contact management, comprising: collecting contact information for a contact; obtaining context information corresponding to the contact information; and integrating the contact information with the context information to provide contextual contact information.

In an embodiment, the context information comprises an entry in an electronic calendar, and the method further comprises integrating the entry in the electronic calendar with the contact information.

In another embodiment, the method further comprises associating a group of contacts with the context information comprising an entry in an electronic calendar.

In another embodiment, the method further comprises providing the contact information for one or more contacts in a calendar view of events in the electronic calendar.

In another embodiment, the method further comprises transmitting a digital image of collected contact information to contact information processing service; and receiving processed contact information for integration with the context information.

In another aspect, there is provided a computer-implemented system for contextual contact management, the system adapted to: collect contact information for a contact; obtain context information corresponding to the contact information; and integrate the contact information with the context information to provide contextual contact information.

In an embodiment, the context information comprises an entry in an electronic calendar, and the system is further adapted to integrate the entry in the electronic calendar with the contact information.

In another embodiment, the system is further adapted to associate a group of contacts with the context information comprising an entry in an electronic calendar.

In another embodiment, the system is further adapted to provide the contact information for one or more contacts in a calendar view of events in the electronic calendar.

In another embodiment, the system is further adapted to: transmit a digital image of collected contact information to a contact information processing service; and receive processed contact information for integration with the context information.

The foregoing description of embodiments has been presented for purposes of illustration and description. It is not intended to be exhaustive or to be limited to the precise forms disclosed, and modifications and variations are possible in light of the above teachings or may be acquired from practice of the invention. The embodiments were chosen and described in order to explain the principals of the invention and its practical application to enable one skilled in the art to utilize the invention in various embodiments and with various modifications as are suited to the particular use contemplated. It is intended that the scope of the invention be defined by the claims appended hereto and their equivalents.

We claim:

1. A computer-implemented method of contextual contact management, comprising:
collecting contact information for a contact;
obtaining context information corresponding to the contact information; and
integrating the contact information with the context information to provide contextual contact information.

2. The computer-implemented method of claim 1 wherein the context information comprises an entry in an electronic calendar, and the method comprises integrating the entry in the electronic calendar with the contact information.

3. The computer-implemented method of claim 2, further comprising associating a group of contacts with the context information comprising an entry in an electronic calendar.

4. The computer-implemented method of claim 2, further comprising providing the contact information for one or more contacts in a calendar view of events in the electronic calendar.

5. The computer-implemented method of claim 1, further comprising:
transmitting a digital image of collected contact information to a contact information processing service; and
receiving processed contact information for integration with the context information.

6. The computer-implemented method of claim 1, further comprising generating a list of contacts to follow up with, including an alert setting a date and time for follow up.

7. The computer-implemented method of claim 6, further comprising managing the list of contacts to follow up with until follow up has occurred and the contact is removed from the list.

8. The computer-implemented method of claim 1, further comprising allowing retrieval of context information on when and where a contact was made for any contact retrieved from a list of contacts.

9. The computer-implemented method of claim 7, further comprising allowing retrieval of context information comprising an entry in an electronic calendar, including the date and number of contacts made.

10. The computers-implemented method of claim 7, further comprising allowing retrieval of context information for an associated group to which the contact is a member.

11. A computer-implemented system for contextual contact management, the system adapted to:
collect contact information for a contact;
obtain context information corresponding to the contact information; and
integrate the contact information with the context information to provide contextual contact information.

12. The computer-implemented system of claim 11 wherein the context information comprises an entry in an electronic calendar, and the system is further adapted to integrate the entry in the electronic calendar with the contact information.

13. The computer-implemented system of claim 12, wherein the system is further adapted to associate a group of contacts with the context information comprising an entry in an electronic calendar.

14. The computer-implemented system of claim 12, wherein the system is further adapted to provide the contact information for one or more contacts in a calendar view of events in the electronic calendar.

15. The computer-implemented system of claim 11, wherein the system is further adapted to:
transmit a digital image of collected contact information to a contact information processing service; and
receive processed contact information for integration with the context information.

16. The computer-implemented system of claim 11, wherein the system is further adapted to generate a list of contacts to follow up with, including an alert setting a date and time for follow up.

17. The computer-implemented system of claim 16, wherein the system is further adapted to manage the list of contacts to follow up with until follow up has occurred and the contact is removed from the list.

18. The computer-implemented system of claim 11, wherein the system is further adapted to allow retrieval of context information on when and where a contact was made for any contact retrieved from a list of contacts.

19. The computer-implemented system of claim 17, wherein the system is further adapted to allow retrieval of context information comprising an entry in an electronic calendar, including the date and number of contacts made.

20. The computer-implemented method of claim 17, wherein the system is further adapted to allow retrieval of context information for an associated group to which the contact is a member.
